(19) United States
(12) Patent Application Publication
(10) Pub. No.: US 2011/0075927 A1
(43) Pub. Date: Mar. 31, 2011

(54) FAST IMAGE SEGMENTATION USING REGION MERGING WITH A K-NEAREST NEIGHBOR GRAPH

(76) Inventors: Mantao Xu, Shanghai (CN); Hongzhi Liu, Shanghai (CN); Qiyong Guo, Shanghai (CN); Jiwu Zhang, Shanghai (CN)

(21) Appl. No.: 12/993,864

(22) PCT Filed: May 29, 2008
(86) PCT No.: PCT/CN08/01046

§ 371 Date: Nov. 22, 2010

(51) Int. Cl. G06K 9/34

(52) U.S. Cl. 382/173

(57) ABSTRACT

The present invention has disclosed a process of image segmentation, which comprises applying edge detection to an image to obtain an edge image and preprocessing the image; oversegmentating the preprocessed image to obtain the plurality of initial partitions; constructing k-NN Graph for the oversegmented image based on the similarity between the initial partitions; and using k-NN Graph to merge the initial partitions. With the present invention, the merging process can be accelerated and the segmentation accuracy can be improved.

### TECHNICAL FIELD

The present application relates to image processing and in particularly to image segmentation.

### BACKGROUND OF THE INVENTION

Image segmentation is a basic technology adopted in image processing and computer vision. The goal of image segmentation is to subdivide an image into its constituent regions which are sets of connected pixels or objects, so that each region itself will be homogeneous whereas different regions will be heterogeneous with each other. The segmentation accuracy may determine the eventual success or failure of many existing techniques for image description and recognition, image visualization, and object based image compression.

The segmentation can be approached by finding boundaries between regions according to discontinuities or by using threshold based on the distribution of pixel properties. In many circumstances, the technology is to directly find the partitions, i.e. the Region-based segmentation. The drive of this technology is to detect regions that satisfy certain predefined homogeneity criteria. Normally, the input image is at first tessellated into a set of homogeneous primitive regions. Then an iterative merging process is applied, within which similar neighboring regions are merged according to certain decision rules. The key of this method is the region homogeneity definition, this being usually determined by hypothesis testing.

So far, many morphologic algorithms have been proposed to obtain the primitive regions and most of them are based on the watershed segmentation algorithms. However, these algorithms are still not satisfactory due to the too many number of the initial regions. Therefore, a better region merging algorithm is desired. When developing a better algorithm, there are three key points in the merging algorithm design: (a) how to measure the homogeneity between regions; (b) how to merge the regions fast; (c) how to terminate the merging process. The present invention focuses on the first two points.

### SUMMARY OF THE INVENTION

An objective of this invention is to provide a fast algorithm for image segmentation.

Aspects of the present invention provide a process of image segmentation, which comprises: applying edge detection to an initial image to obtain an edge image, and preprocessing the initial image; oversegmentating the preprocessed image to obtain a plurality of initial partitions; constructing k-NN Graph for the oversegmented image based on the similarity between the initial partitions as well as the edge image; and using the k-NN Graph to merge the initial partitions.

The preprocessing step comprises applying smooth filter to the image. And the oversegmentation step can be realized by Watersheds-based Segmentation algorithm or Region Growing algorithm.

Further aspects of the present invention provide functions to compute the similarity between two pixels and the similarity between two regions respectively.

### BRIEF DESCRIPTION OF THE DRAWINGS

Features as well as advantages of the present invention will become to be more apparent to those skilled in the art from the following detailed description of the preferred embodiments when taking reference to the accompanying figures in which identical figure references identify similar or corresponding objects throughout the entire description of the present invention.

In these figures,

FIG. 1 illustrates a process of the fast image segmentation of the present invention;

FIG. 2 illustrates Kirsch's mask and its rotations;

FIG. 3 illustrates the double linked list structure for k-NN graph node (k=2).

### DETAILED DESCRIPTION OF THE INVENTION

Let R={p₁, p₂, . . . , p_{N}} represents the set of the entire image region, in which pᵢ(1<i<N) represents the image pixels within the region. The segmentation can be regarded as a process that partitions R into K subregions, R₁, R₂, . . . , Rₖ, such that

$$\begin{matrix}( a ) R = {⋃}_{k = 1}^{K} {R}_{k} & ( 1 ) \\ ( b ) {R}_{i} ⋂ {R}_{j} = φ , ∀ i , j ∈ \{ 1 , 2 , … , K \} , i \neq j , & \\ ( c ) P ( {R}_{k} ) = TRUE , ∀ k ∈ \{ 1 , 2 , … , K \} , & \\ ( d ) P ( {R}_{i} ⋃ {R}_{j} ) = FALSE , ∀ i , j ∈ \{ 1 , 2 , … , K \} , i \neq j & \end{matrix}$$

Here, P(Rᵢ) is a logical predicate defined over the pixels in set Rᵢ and φ is the null set.

Eq. (1)(a) indicates that the segmentation must be complete, or each pixel must be in a region while Eq. (1)(b) suggests that the regions must be disjointed with each other. Eq. (1)(c) and Eq. (1)(d) guarantee that all pixels in a segmented region Rᵢ have the same properties, but different regions Rᵢ and Rⱼ are at least different in the sense of one predicate P.

Normally term Δ_{K}(R)={R₁, R₂, . . . , R_{K}} is defined to denote the segment procedure with K denoting the number of the regions in Δ_{K}(R) . In the present invention, an oversegmentation is performed on the image first of all to obtain an initial image partition Δ_{K}_{₀}(R) . It is assumed that there exists a sequence of region merging that transforms Δ_{K}_{₀}(R) into true partition Δ_{K*}(R) , here K* is the number of the regions in Δ_{K*}(R) and K₀≧K*. This can be regarded as that each Region Rᵢ^{K*} in Δ_{K*}(R) is a union of certain regions in Δ_{K}_{₀}(R). To acquire the sequence, a novel region merging method using a k-NN graph is applied to initial partitions Δ_{K}_{₀}(R) . At each step of the merging process, the most similar pair of regions is merged and finally true partition Δ_{K*}(R) is obtained.

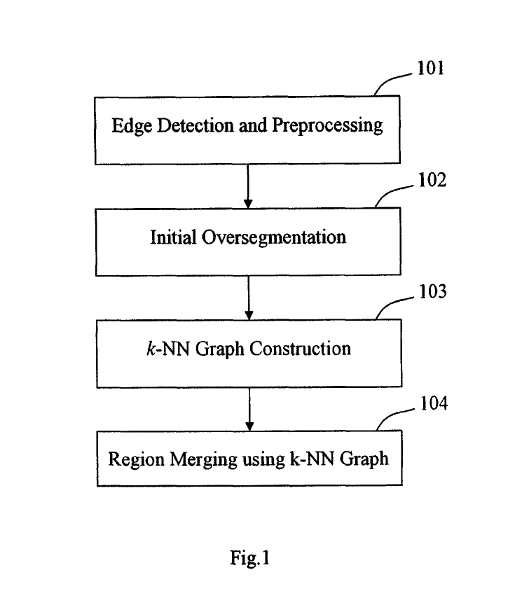

FIG. 1 is a flow chart showing the four steps of the proposed segmentation algorithm. The aim of step 101 is to prepare for the following processing. In step 101 an edge detection process is applied and the preprocessing can also be performed if needed. For example, if the image is with Gaussian White Noise, a filter can be applied to obtain a smooth image before further process.

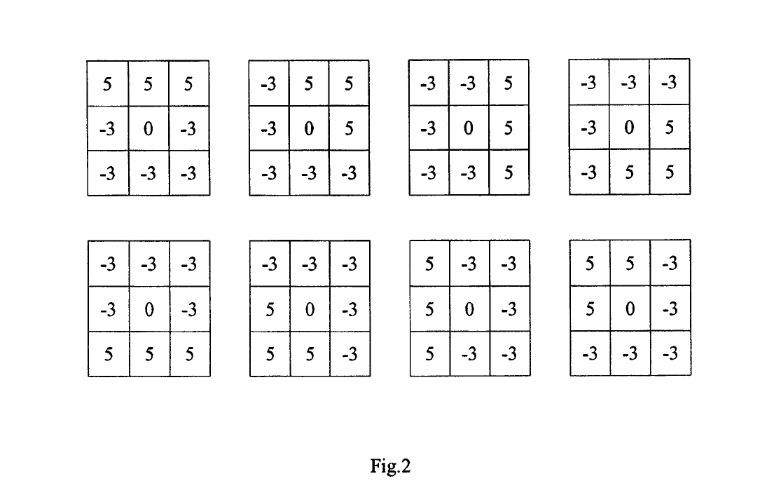

If a pixel falls on the boundary of an object in an image, then its neighborhood will be a zone of intensity transition. The two characteristics of principal interest are the slope and direction of that transition. Edge detection examines each pixel neighborhood and quantifies the slope, and often the direction as well, of the intensity transition. There are several ways to do this, for example, applying Kirsch's mask and different rotations of it (as shown in FIG. 2) to the image, and then thresholding the raw edge image to obtain the edge image. By doing this, sharp edges or significant edges can be preserved.

Referring back to FIG. 1, in step 102, the preprocessed image is oversegmented so that the primitive partitions, which are many tiny regions, are obtained. The oversegmentation can be realized by various approaches. There are two requirements to the oversegmentation algorithm: (a) it must be implemented simply and get results quickly; (b) the number of the primitive partitions should be in a certain range, the size of partitions should be appropriate, and the property in a partitions should be consistent which satisfies Eq. (1) indicated above. In practice, there are lots of approaches, which meet such requirement, such as Watersheds-based Segmentation or Region-based Algorithm, and the latter can be Region Growing Algorithm.

In step 103, k-NN graph is built based on the output of the initial partitions obtained in step 102.

Firstly, a new region similarity measure function using local features along region edges is designed.

Normally the similarity of the features of two regions is measured through computing the difference between the two regions. For simplicity, global features are often extracted, for example, the mean value of the pixels in a region Ri and spatial distance of two regions' centroids can be used for achieving this goal. But the global feature may often lead to a false merge. For example, if two big regions have a sharp difference along their edge while their global intensity means are almost the same, the algorithm will usually pick the two to merge. To overcome the drawback of global features, a new region similarity is proposed based on the pixel's similarity.

Taking a brightness image for example, for pixel pᵢ and pⱼ in image I, their similarity is defined as following:

$${ω}_{ij} = \{ \begin{matrix}{e}^{\frac{{‖ {I}_{i} - {I}_{j} ‖}^{2}}{{σ}_{1}^{2}} \frac{{Edge}^{2} ( i , j )}{{σ}_{2}^{2}}} & ‖ {X}_{i} - {X}_{j} ‖ \leq r \\ 0 & ‖ {X}_{i} - {X}_{j} ‖ > r\end{matrix} \qquad ( 2 )$$

wherein, Xᵢ and Iᵢ denote the coordinate and intensity of pᵢ respectively;

the edge response Edge(i,j) is the maximum value on the line connecting pᵢ and pⱼ in the edge image, which denotes the probability of an edge that exists between pᵢ and pⱼ;

σ₁ and σ₂ are the parameters to modify the force of intensity and edge features in ωᵢⱼ; and parameter r represents radius.

If two pixels are too far away, or their distance is more than r, ωᵢⱼ is directly set to be 0. Here just intensity, edge feature and spatial distance are used. However, if other features are wanted, the only additional work is to define a function in the form like Edge feature and make ωᵢⱼ multiplied with the defined item.

Let dᵢ=Σⱼωᵢⱼ be the total connection from pᵢ to all other pixels. With the pixel similarity ωᵢⱼ and di, the similarity between regions A and B is defined as:

$$W ( A , B ) = \frac{{\sum }_{i ∈ A , j ∈ B} {ω}_{ij}}{\sqrt{( {\sum }_{i ∈ A} {d}_{i} ) ( {\sum }_{i ∈ B} {d}_{i} )}} \qquad ( 3 )$$

The region similarity is the sum of the pixel similarity between pixels from regions A and B. To avoid the preference of merge between big regions, the sum is divided by the normalized item, square root of the product of

$${\sum }_{i ∈ A} {d}_{i} and {\sum }_{i ∈ B} {d}_{i} \cdot {\sum }_{i ∈ A} {d}_{i} and {\sum }_{i ∈ B} {d}_{i}$$

can be regarded as the volume of regions A and B.

Different from other definitions, disjoint regions may have high similarity value in the present definition. This can improve the detail parts, especially the small disjoint part of the segmentation. Besides, the influential range of the region can be controlled according to the modification of the pixel similarity radius r. If r is small, the similarity between two regions can be decided mainly by a part of pixels along their edge. According to the above formulation, the most similar pair of regions is the one which have high value of W.

There is no limit that edges must exist between adjacent regions in the region similarity definition (3), so every region may have more neighbors. This is why k-nearest neighbor (k-NN) graph, rather than the traditional data structure region adjacency graph (RAG), is adopted. The k-NN graph is a weighted directed graph G=(V, E, W) , wherein V is the set of nodes representing regions and E is the set of edges representing pointers from a region to its neighboring regions. Every node has exactly k edges to the k nearest regions. All the region similarities are computed and assigned to the corresponding edges as weight. The graph is utilized so that the search is limited only to the regions that are directly connected by the graph structure. This reduces the time complexity of every search. The parameter k affects the quality of the final segmentation results and the running time. If the number of neighbors k is small, significant speedup can be obtained. And it has been proven that a small k can reach a good approximated result.

Brute force is a commonly adopted method to compute the region similarity W(a, b). Let Δ_{K}_{₀}(R) be the primitive segmentation. For a region Rₐ, an array S of size K₀ is defined to contain the similarity to other regions. All the values in S are set to 0. Every pixel in Rₐ is traveled, if the pixel has a neighbor in region R_{b}, the corresponding pixel similarity is add to S[b]. Then S[b] is divided by the square root of the product of volume of Rₐ and R_{b} to obtain the W(a, b).

Insert sort is used for adding R_{b} to the nearest neighbor link of Rₐ. After all the neighbors are computed, only k nearest neighbors are kept in every node.

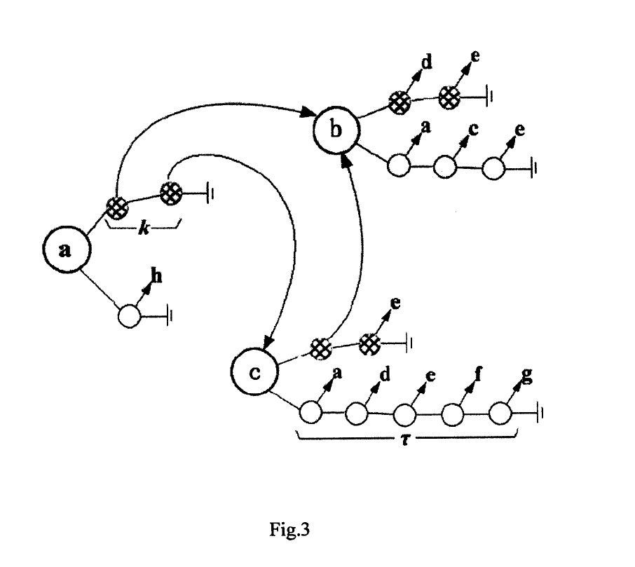

While constructing the list of link of Rₐ, the back pointer link is constructed. FIG. 3 shows the node structure of k-NN graph. For each node, two lists are maintained: the k-NN list containing the pointers to its k nearest neighbors and back pointer list containing the back pointers which point to the regions taking the node point as one of their k nearest neighbors. The one with grid spheres is the back pointer list. For example, in FIG. 3, there are five regions that take region c as their nearest neighbors. All of them appear in the back pointer lists of c(a,d,e,f,g). Using back pointers is to accelerate the process of finding the nodes whose nearest neighbor is the current one in the merging process. The k nearest neighbors are stored in descendent order so that the nearest neighbor is always the first one in the list.

Referring back to FIG. 1, step 104 is the last one, and in step 104 regions are merged using the k-NN graph.

All nodes are stored in a heap by their similarity to the nearest one neighbor, which can speed up the finding of the most similar pair. Given the k-NN graph of the initial K-partition, the merging is processed in the following algorithm, wherein, parameter n is the times of the iteration.

Input: k-NN graph of K₀ partition

Iteration: For i=0 to n−1
Find the most similar pair (Rₐ, R_{b}) to be merged.
Merge pair (Rₐ, R_{b})→R_{ab}.
Update the k-NN graph to (K₀−i−1) partition.

Output: k-NN graph of (K₀−n) partition

In each merging iteration, the most similar pair of nodes (Rₐ, R_{b}) is found, then, nodes Rₐ and R_{b} are merged into one node R_{ab}. The k nearest neighbors are selected from the 2k neighbors of the previously merged nodes Rₐ and R_{b} to keep the computation complexity reasonable. This means that the accuracy of the k-NN graph is compromised and, thus, the graph becomes an approximated nearest neighboring graph. It may also occur that the number of neighbors for the cluster R_{ab} can become smaller than k. At last node Rₐ is replaced by R_{ab} and the second node R_{b} is removed from the k-NN graph. The similarity to the neighbors of R_{ab} is recomputed, which is a double process, both the edges from R_{ab} and the edges pointed to R_{ab} should be computed. At the same time, insertion sort is applied and no more than k nearest neighbors are kept. Another operation in graph updating is to update the heap.

Predefining the value of K* is the simplest way to stop the merging iteration. As long as the number of regions is K*, the iteration stops automatically. But this needs interaction and different images may need different K*. Another way to stop the iteration is using the region similarity. If the global maximum region similarity value (3) is smaller than a certain threshold, the merging process will be terminated. This threshold can be set directly by user or be determined automatically by using the knowledge on the noise distribution.

The present invention can handle colorful or grayscale image and obtain the output of the segmented regions of the image. It can be the input of many further image processing tasks. In the present invention, the new region similarity definition based on local pixel similarity can use kinds of image features in a unit form. Regions are merged according to the pixels similarity along their edge instead of the global mean feature distance. In this way, the drive of assigning similar pixels in the same region can be actually realized, which means the segmentation accuracy is improved. It should be noted that, not only the color and edge features, but also other features, such as gratitude, special distance and texture can be used in our segmentation framework Furthermore, by using a k-NN graph, the merging process is accelerated.

The embodiments of the invention described above are intended to be exemplary only. Those skilled in the art may understand that the provided embodiments can be further varied in many aspects. For example, another range for the modulation parameter k can be defined according to the actual medical practice. The scope of the invention is therefore intended to be limited solely by the scope of the appended claims.

We claim:

1. A process of image segmentation, which comprises:
applying edge detection to an initial image to obtain an edge image, and preprocessing the initial image;
oversegmentating the preprocessed image to obtain the plurality of initial partitions;
constructing k-NN Graph for the oversegmented image based on the similarity between the initial partitions as well as the edge image; and
using k-NN Graph to merge the initial partitions.

2. The process of claim 1, wherein the preprocessing step comprises applying smooth filter to the image.

3. The process of claim 1, wherein the oversegmentation step can be realized by Watersheds-based Segmentation Algorithm.

4. The process of claim 1, wherein the oversegmentation step can be realized by a Region-based Algorithm.

5. The process of claim 4, wherein the Region-based Algorithm is Region Growing Algorithm.

6. The process of claim 1, wherein the similarity between the partitions is computed based on the sum of the similarity between pixels in the partitions, and is divided by a normalized item to make the similarity value between regions to be irrelevant to the size of the regions.

7. The process of claim 6, wherein similarity W between the partitions is computed as follows:
$$W ( A , B ) = \frac{{\sum }_{i ∈ A , j ∈ B} {ω}_{ij}}{\sqrt{( {\sum }_{i ∈ A} {d}_{i} ) ( {\sum }_{i ∈ B} {d}_{i} )}}$$
wherein, W(A,B) is the similarity between partitions A and B; ωᵢⱼ is the similarity between pixels pᵢ and pⱼ; and dᵢ=Σⱼωᵢⱼ is the total connection from pᵢ to all other pixels.

8. The process of claim 6, wherein the similarity between two pixels is computed based on the pixel's intensity, the maximum value on the line connecting the two pixels, and the spatial distance between the two pixels.

9. The process of claim 6, wherein the similarity between the pixels is computed as follows:
$${ω}_{ij} = \{ \begin{matrix}{e}^{\frac{{‖ {I}_{i} - {I}_{j} ‖}^{2}}{{σ}_{1}^{2}} \frac{{Edge}^{2} ( i , j )}{{σ}_{2}^{2}}} & ‖ {X}_{i} - {X}_{j} ‖ \leq r \\ 0 & ‖ {X}_{i} - {X}_{j} ‖ > r\end{matrix}$$
wherein Xᵢ denotes the coordinate of pᵢ; Iᵢ denotes the intensity of pᵢ; Edge(i,j) is Edge feature, that is the maximum value on the line connecting pᵢ and pⱼ in the edge image; σ₁ and σ₂ are the parameters to modify the force of intensity and edge features in ωᵢⱼ; and r represents radius.

10. The process of claim 9, wherein features other than intensity, Edge feature and spatial distance can also be used for computing the similarity by defining an item in the form like Edge feature and making ωᵢⱼ multiplied by the defined item.

11. The process of claim 1, wherein the similarity between the initial partitions is computed in the brute force manner.
